(19) United States
(12) Patent Application Publication
(10) Pub. No.: US 2012/0305026 A1
(43) Pub. Date: Dec. 6, 2012

(54) Substrate Processing Apparatus and Substrate Processing Method

(75) Inventors: Hisashi Nomura, Toyama (JP); Yohei Noguchi, Toyama (JP); Shinichi Noguchi, Osaka (JP); Tomoshi Taniyama, Toyama (JP)

(73) Assignee: HITACHI KOKUSAI ELECTRIC INC., Tokyo (JP)

(21) Appl. No.: 13/482,527

(22) Filed: May 29, 2012

(30) Foreign Application Priority Data
May 31, 2011 (JP) 2011-122687
May 10, 2012 (JP) 2012-108484

(51) Int. Cl. B08B 7/04

(52) U.S. Cl. 134/10; 134/56 R

(57) ABSTRACT

A film-forming method and a substrate processing apparatus are provided, which are capable of improving productivity of an epitaxial film of GaN by increasing the number of substrates to be processed at one time. The substrate processing apparatus for processing a substrate including an epitaxial film includes: a processing chamber configured to process the substrate, a gas supply unit configured supply a source gas for forming the epitaxial film and a cleaning gas into the processing chamber, and a control unit configured to control at least an inside temperature and an inside pressure of the processing chamber, wherein the control unit controls the gas supply unit to supply the cleaning gas into the processing chamber when the inside temperature and the inside pressure of the processing chamber reach a predetermined temperature and a predetermined pressure, respectively.

### CROSS REFERENCE TO RELATED APPLICATIONS

This application claims foreign priority under 35 U.S.C. §119(a)-(d) to Japanese Patent Application No. 2011-122687 filed on May 31, 2011, entitled “Substrate Processing Apparatus and Substrate Processing Method,” and Japanese Patent Application No. 2012-108484, filed on May 10, 2012, entitled “Substrate Processing Apparatus and Substrate Processing Method,” the entire contents of each of which are hereby incorporated by reference.

### FIELD OF THE INVENTION

The present invention relates to a substrate processing apparatus and substrate processing method of a of a semiconductor device.

### BACKGROUND

An epitaxial film of a compound semiconductor such as gallium nitride (GaN) is grown on a substrate disposed on a susceptor inside a processing chamber under a high temperature by heating the substrate using a heater and supplying a source gas to an inside of the processing chamber (see Japanese Patent Unexamined Application No. 2009-117618).

However, when the epitaxial film is formed on the substrate using an apparatus having such a configuration, reactants are attached to gas jets for ejecting the source gas. Therefore, when the processing is consecutively performed, since the processing is affected by the reactants attached to the gas jets, there is a problem in that a film-forming amount is changed.

In addition, in order to prevent the change of the film-forming amount, when performing a self-cleaning process in a reactor, a cleaning gas remains in an inside of the processing apparatus. Therefore, when performing following processing, there are problems in that a film thickness is changed or gases are volatilized. In addition, after the film is formed, when peeling and recycling a carrier substrate from the film, the formed film remains in a surface of the carrier substrate peeled from the film. Accordingly, there is a need to polish the surface of the carrier substrate in order to recycle the carrier substrate. However, when the surface of the carrier substrate is polished, the carrier substrate itself is reduced. Therefore, since the thickness of the carrier substrate itself is thinner and a predetermined strength cannot be maintained, there are problems in that the carrier substrate is often discarded and the running cost increases.

### SUMMARY

It is an object of the present invention to provide a method of fabricating a semiconductor device and a substrate processing apparatus in which self-cleaning can be performed in an inside of a processing chamber and thus the processing of forming a film can be consecutively performed. In addition, it is another object of the present invention to provide a method of fabricating a semiconductor device and a substrate processing apparatus capable of promoting cost reduction and improving productivity by reclaiming a substrate in which film thickness is difficult to control after completing film formation.

According to one aspect of the present invention, there is provided a substrate processing apparatus for processing a substrate including an epitaxial film, including: a processing chamber configured to process the substrate; a gas supply unit configured supply a source gas for forming the epitaxial film and a cleaning gas into the processing chamber; and a control unit configured to control at least an inside temperature and an inside pressure of the processing chamber, wherein the control unit controls the gas supply unit to supply the cleaning gas into the processing chamber when the inside temperature and the inside pressure of the processing chamber reach a predetermined temperature and a predetermined pressure, respectively.

According to another aspect of the present invention, there is provided a substrate processing method performed in a substrate processing apparatus including a processing chamber for processing a semiconductor substrate, the method including: a processing chamber cleaning process of cleaning an inside of the processing chamber; a substrate reclaiming process of reclaiming the semiconductor substrate; and a cleaning gas removing process of removing a cleaning gas used in one of or both of the processing chamber cleaning process and the substrate reclaiming process.

The present invention can provide a method of manufacturing a semiconductor device and a substrate processing apparatus capable of improving productivity.

### BRIEF DESCRIPTION OF THE DRAWINGS

FIG. 1 is a schematic configuration diagram of a substrate processing apparatus according to one embodiment of the present invention.

FIG. 2 is a longitudinal sectional view of a processing furnace included in the substrate processing apparatus according to one embodiment of the present invention.

FIG. 3 is a perspective view of an inner tube included in the substrate processing apparatus according to one embodiment of the present invention.

FIG. 4 is a cross-sectional view of a process tube included in the substrate processing apparatus according to one embodiment of the present invention.

FIG. 5 is a sequence diagram of a gas supply when cleaning a substrate, which is one of substrate processing methods according to one embodiment of the present invention.

FIG. 6 is an exemplary flow chart of a substrate processing method according to one embodiment of the present invention.

### DETAILED DESCRIPTION

### First Embodiment of the Present Invention

Hereinafter, a first embodiment of the present invention will be described in detail with reference to the appended drawings.

### (1) Configuration of Substrate Processing Apparatus

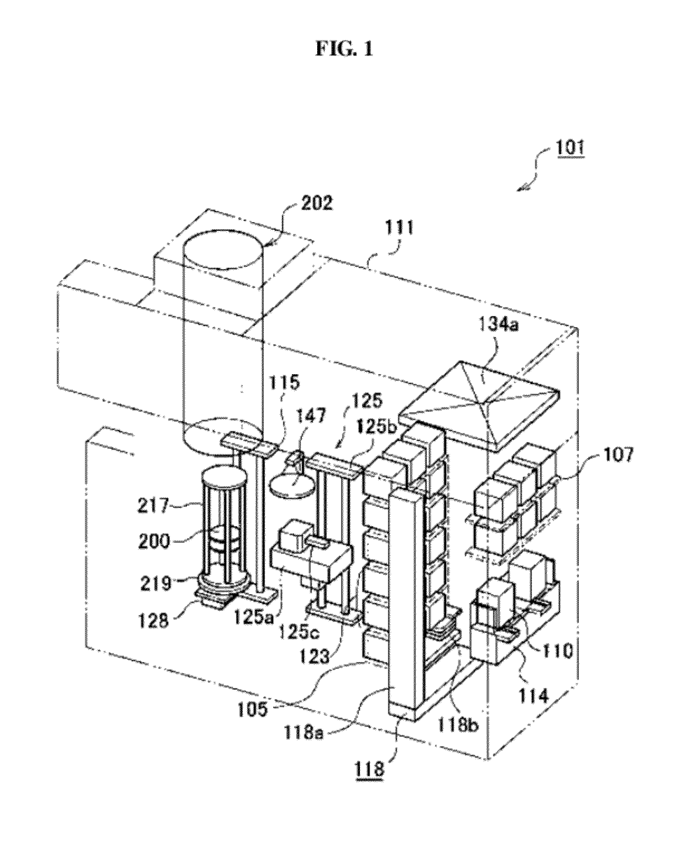

First, a configuration example of a substrate processing apparatus 101 according to the first embodiment of the present invention will be described with reference to FIG. 1.

As shown in FIG. 1, the substrate processing apparatus 101 according to the embodiment of the present invention includes a housing 111. In order to transport a wafer 200 (substrate) consisting of silicon, Al₂O₃ (sapphire) or the like inside or outside the housing 110, a cassette 110 is used as a wafer carrier (substrate accommodating container) to accommodate a plurality of wafers 200. The front of an inner side of the housing 111 (on the right side of FIG. 1) is provided with a cassette stage 114 (substrate accommodating container delivery unit). The cassette 110 may be configured to be placed on the cassette stage 114 by a transporting device (not shown) in the process and to be unloaded from the cassette stage 114 to the outside of the housing 111.

The cassette 110 is placed on the cassette stage 114 such that the wafer 200 in the cassette 110 is in a vertical posture and a wafer entrance of the cassette 110 faces an upper direction by a transporting device in the process. The cassette stage 114 rotates the cassettes 110 in a movement direction, that is, in the longitudinal direction toward a rear part (on the left side of FIG. 1) of the housing 111 for performing the substrate processing, 90 degrees to be in a horizontal posture. Thus, the wafer entrance of the cassette 110 can face the rear part in the housing 111.

A substantial central portion in the front and back directions in the housing 111 is provided with a cassette shelf 105 (substrate accommodating container placement shelf). The cassette shelf 105 is configured to store a plurality of cassettes 110 in a plurality of stages and a plurality of lines. The cassette shelf 105 is provided with a transfer shelf 123 at which the cassette 110, which is a transporting target of a wafer transfer mechanism 125 to be described later, is accommodated. In addition, an upper part of the cassette stage 114 is provided with a preliminary cassette shelf 107 configured to preliminarily store the cassette 110.

A cassette transporting device 118 (substrate accommodating container transporting device) is provided between the cassette stage 114 and the cassette shelf 105. The cassette transporting device 118 includes a cassette elevator 118a (substrate accommodating container elevating mechanism) capable of elevating while holding the cassette 110, and a cassette transporting mechanism 118b (substrate accommodating container transporting mechanism) as a transporting mechanism capable of horizontally moving while holding the cassette 110. According to operations in conjunction with the cassette elevator 118a and a cassette transporting mechanism 118b, the cassette 110 may be transported among the cassette stage 114, the cassette shelf 105, the preliminary cassette shelf 107, and the transfer shelf 123.

A rear part of the cassette shelf 105 is provided with a wafer transfer mechanism 125 (substrate transfer mechanism). The wafer transfer mechanism 125 includes a wafer transfer device 125a (substrate transfer device) that can rotate or directly move the wafer 200 in a horizontal direction, and a wafer transfer device elevator 125b (substrate transfer device elevating mechanism) that can elevate the wafer transfer device 125a. Meanwhile, the wafer transfer device 125a includes tweezers 125c (substrate transfer jig) that hold the wafer 200 in the horizontal posture. According to operations in conjunction with the wafer transfer device 125a and the wafer transfer device elevator 125b, the wafer 200 is picked up from the cassette 110 on the transfer shelf 123 to be loaded (charged) into a boat 217 (substrate holder) to be described later, or the wafer 200 is unloaded (discharged) from the boat 217 to be accommodated in the cassette 110 on the transfer shelf 123.

A rear upper part of the housing 110 is provided with a processing furnace 202. A lower end of the processing furnace 202 is provided with an opening (furnace opening) and the opening is opened and closed by a furnace opening shutter 147 (opening and closing mechanism of furnace opening). In addition, a configuration of the processing furnace 202 will be described later.

A lower part of the processing furnace 202 is provided with a boat elevator 115 (substrate holder elevating mechanism) as an elevating mechanism to transport the boat to the inside or the outside of the processing furnace 202 by elevating the boat 217. An elevating stand of the boat elevator 115 is provided with an arm 128 as a connecting tool. On the arm 128A, a seal cap 219 of a disk shape is provided in a horizontal posture as a lid body air-tightly closing the lower end of the processing furnace 202 when the boat 217 is elevated by the boat elevator 115 while supporting the boat 217 vertically.

The boat 217 includes a plurality of holding members and holds the plurality of (for example, 50 to 150) wafers 200 in a multi-stage to be aligned in the horizontal posture and in a vertical direction at its center-aligned state. The detailed configuration of the boat 217 will be described later.

An upper part of the cassette shelf (105) is provided with a cleaning unit 134a having a supply fan and a dust filter. The cleaning unit 134a circulates clean air, which is a cleaned atmosphere, inside the housing 11.

In addition, a left end portion of the housing 111, which is opposite to the wafer transfer device elevator 125b and the boat elevator 115 sides, is provided with a cleaning unit (not shown) having a supply fan and a dust filter to supply clean air. The clean air blown by the cleaning unit (not shown) is circulated around the wafer transfer device 125a and the boat 217 and then sucked into an exhaust device (not shown) to be exhausted from the housing 111.

### (2) Operation of Substrate Processing Apparatus

Next, the operation of the substrate processing apparatus 101 according to this embodiment will be described.

First, the cassettes 110 are placed on the cassette stage 114 such that the wafer 200 in the cassette 110 is in a vertical posture and a wafer entrance of the cassette 110 faces the upper part by a transporting device (not shown) in the process. Then, the cassette 110 rotates 90 degrees in the longitudinal direction toward the rear part of the housing 111 by the cassette stage 114. As a result, the wafer 200 in the cassette 110 is in the horizontal posture and the wafer entrance of the cassette 110 faces the rear part in the housing 111.

The cassette 110 may be automatically transported and passed on specified shelf positions of the cassette shelf 105 or the preliminary cassette shelf 107 by the cassette transporting device 118. Thus, after the cassette 110 is temporarily stored, the cassette 110 may be transferred on the transfer shelf 123 from the cassette shelf 105 or the preliminary cassette shelf 107 or may be transported on the transfer shelf 123 directly.

When the cassette 110 is transferred on the transfer shelf 123, the wafer 200 is picked up from the cassette 110 via the wafer entrance by the tweezers 125c of the wafer transfer device 125a and loaded (charged) into the boat 217 located on the rear part of the transfer chamber 124 by continuous operations of the wafer transfer device 125a and the wafer transfer device elevator 125b. The wafer transfer mechanism 125, which passes the wafer 200 to the boat 217, returns to the cassette 110 and loads the next wafer 200 into the boat 217.

When a pre-designated number of wafers 200 are loaded into the boat 217, the lower end of the processing furnace 202 closed by the furnace opening shutter 147 is opened by the furnace opening shutter 147. Subsequently, as the seal cap 219 is elevated by the boat elevator 115, the boat 217 that holds a group of wafers 200 is loaded into the processing furnace 202. After loading, processing is performed on the wafer 200 in the processing furnace 202. This processing will be described later. After processing, the wafer 200 and the cassette 110 are withdrawn to the outside of the housing 111 in reverse order from the described order.

### (3) Configuration of Processing Furnace

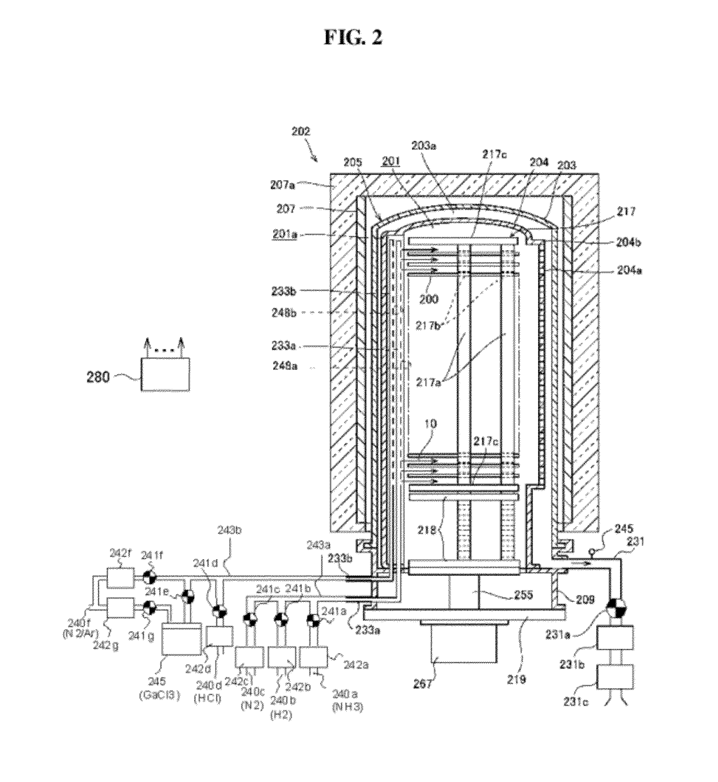

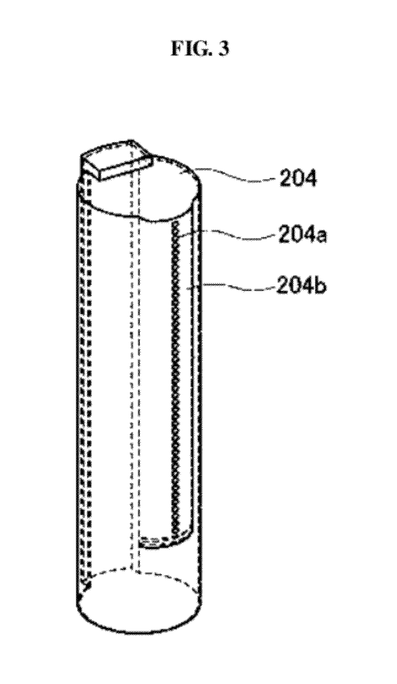

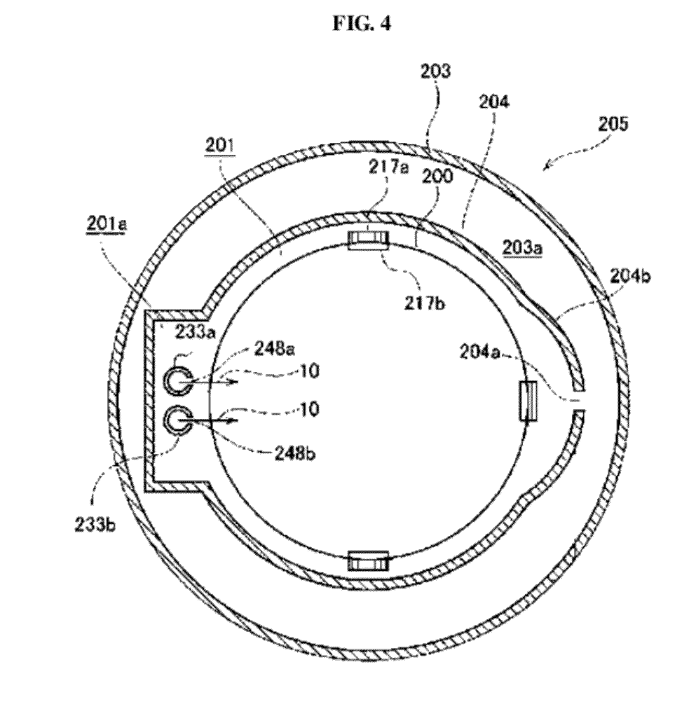

Next, the configuration of the processing furnace 202 according to the embodiment of the present invention will be described with reference to FIGS. 2 to 4.

### Processing Chamber

The processing furnace 202 according to one embodiment of the present invention includes a process tube 205 as a reaction tube, and a manifold 209. The process tube 205 includes an inner tube 204 accommodating the wafer 200 as a substrate and an outer tube 203 surrounding the inner tube 204. The inner tube 204 and the outer tube 203 include non-metallic materials having heat resistance such as quartz (SiO₂) or silicon carbide (SiC) and have cylindrical shapes with its upper part closed and its lower part open. The manifold 209 includes metallic materials such as SUS, and has a cylindrical shape in which an upper part and a lower part are open. The inner tube 204 and the outer tube 203 are supported by the manifold 209 in a longitudinal direction from the lower end side. The inner tube 204, the outer tube 203, and the manifold 209 are arranged concentrically with one another. When the boat elevator 115 as described above is elevated, a lower end (furnace opening) of the manifold 209 is air-tightly sealed by the seal cap 219. A sealing member (not shown) such as an O ring that air-tightly seals the inside of the inner tube 204 is provided between the lower end of manifold 209 and the seal cap 219.

The inside of the inner tube 204 is provided with the processing chamber 201 (substrate processing region) that processes the wafer 200. The boat 217 is inserted into the inner tube 204 (into the processing chamber 201) from below as a substrate holder (holding tool). Inner diameters of the inner tube 204 and the manifold 209 are greater than the maximum contour of the boat 217 loading the wafer 200.

The boat 217 includes a pair of end plates 217c disposed vertically and a plurality of struts 217a (three, for example) vertically provided between the pair of end plates 217c. The end plate 217c and the strut 217a include non-metallic materials having heat resistance such as quartz or silicon carbide. Each strut 217a is provided with a plurality of retaining grooves 217b so as to be arranged in regular intervals along the longitudinal direction of the strut 217a. Each of the struts 217a is arranged such that the retaining grooves 217b formed on each of the struts 217a face each other. By inserting the outer periphery of the wafer 200 into each retaining groove 217b, a plurality of wafers 200 (for example, 75 to 100) are retained in a multi-stage to be aligned in a substantially horizontal posture and have a predetermined gap (substrate pitch interval). Thus, the number of substrates to be processed can be increased and productivity can be improved by arranging the plurality of wafers 200 in the longitudinal direction.

In addition, the boat 217 is mounted on a heat insulation cap 218 to block heat conduction. The heat insulation cap 218 is supported from below by a rotating shaft 255. The rotating shaft 255 is provided so as to penetrate a center portion of the seal cap 219 while maintaining air-tightness in the inner tube 204. A lower portion of the seal cap 219 is provided with a rotation mechanism 267 for rotating the rotation shaft 255. By rotating the rotation shaft 255 using the rotation mechanism 267, the boat 217 on which the plurality of wafers 200 are mounted can be rotated while maintaining the air-tightness in the inner tube 204.

A heater 207 as a heating mechanism is provided concentrically with the process tube 205 on the outer periphery of the process tube 205 (outer tube 203). The heater 207 has a cylindrical shape and is vertically provided to be supported by a heater base (not shown) as a holding plate. A heat insulation material 207a is provided on the upper end and the outer periphery of the heater 207. In addition, a temperature detection sensor (not shown) is provided in the outer tube 203 as a temperature detection body for detecting a temperature in the processing chamber 201.

### Preliminary Chamber and Gas Nozzle

A preliminary chamber 201a is provided on a sidewall of the inner tube 204, the preliminary chamber 201a being projected in a radial outer side (sidewall side of the outer tube 203) of the inner tube 204 rather than the sidewall of the inner tube 204, along a direction (vertical direction) in which the wafer 200 is loaded. Since a partition wall is not provided between the preliminary chamber 201a and the processing chamber 201, the preliminary chamber 201a and the processing chamber 201 are communicated with each other such that a gas can be circulated therein

A first gas nozzle 233a and a second gas nozzle 233b are disposed in the preliminary chamber 201a along the circumferential direction of the inner tube 204. The first gas nozzle 233a and the second gas nozzle 233b may be configured to have an L-shape including a vertical portion and a horizontal portion, respectively. The vertical portions of the first gas nozzle 233a and the second gas nozzle 233b are each disposed (extended) in the preliminary chamber 201a along a direction in which the wafers 200 are stacked. The horizontal portions of the first gas nozzle 233a and the second gas nozzle 233b are provided so as to penetrate a sidewall of the manifold 209, respectively.

A plurality of first gas jets 248a and a plurality of second gas jets 248b are each disposed on the vertical portion sides of the first gas nozzle 233a and the second gas nozzle 233b along the direction (vertical direction) in which the wafers 200 are stacked. In addition, the first gas jet 248a and the second gas jet 248b are disposed on (height) locations corresponding to each of the plurality of wafers 200. In addition, opening diameters of the first gas jet 248a and the second gas jet 248b can be suitably adjusted to optimize flow rate distribution or velocity distribution of gases in the inner tube 204, adjusted to be the same across the upper part from the lower part and gradually increased across the upper part from the lower part. In addition, one first gas nozzle 233a and one second gas nozzle 233b or a plurality of first gas nozzles 233a and a plurality of second gas nozzles 233b may be provided.

### Gas Supply Unit

A first gas supply pipe 243a is connected to a horizontal end (upstream side) of the first gas nozzle 233a protruding from the sidewall of the manifold 209. The upstream side of the first gas supply pipe 243a is provided with an opening and closing valve 241a, an opening and closing valve 241b and an opening and closing valve 241c. In addition, an upstream end of the opening and closing valve 241a is provided with an ammonia (NH₃) supply source 240a through a flow rate controller 242a (hereinafter, referred to as “MFC”). In addition, the upstream end of the opening and closing valve 241b is provided with a hydrogen (H₂) gas supply source 240b through an MFC 242b and a nitrogen (N₂) gas supply source 240c through an MFC 242c.

Meanwhile, the second gas supply pipe 243b is connected to a horizontal end (upstream side) of the second gas nozzle 233b. The upstream side of the second gas supply pipe 243b is provided with an opening and closing valve 241d, an opening and closing valve 241e and an opening and closing valve 241f. In addition, the upstream end of the opening and closing valve 241d is provided with a hydrogen chloride gas (HCL) supply source 240d through an MFC 242d and the upstream end of the opening and closing valve 241f is provided with an inert gas (for example, Ar) supply source 240f through an MFC 242f. The upstream end of the opening and closing valve 241e is provided with a tank 245 in which gallium source, for example, gallium chloride (GaCl₃), is stored. The gallium chloride is a solid at room temperature, but is stored in a liquefied state by heating above a melting point of 78° C. In addition, the inert gas (for example, Ar) is supplied to the tank 245 through an MFC 242g and an opening and closing valve 241g. Gallium chloride gas formed by evaporating the liquid gallium chloride gas in liquid phase in the tank 245 is supplied to the second gas supply pipe 243b through the opening and closing valve 241e, along with an inert gas supplied as a carrier gas to the tank 245.

Here, in general, an organometallic source gas such as trimethyl gallium (hereinafter referred to as “TMG”) or triethyl gallium (hereinafter referred to as “TEG”) is often used as a source gas of gallium (Ga) in addition to the above-mentioned gallium chloride. On the other hand, if the plurality of wafers are arranged in the longitudinal direction as in the present invention to achieve improved productivity, it is necessary to provide gas nozzles that are extended in the longitudinal direction in order to maintain uniformity between surfaces of the plurality of wafers. In this case, when the above-mentioned organometallic source gas is used, since the source gas is decomposed by heat while the source gas reaches at a downstream side (upper side of the processing chamber), a reaction rate cannot be controlled at the upstream side and the downstream side of the source gas. Accordingly, in this present invention, gallium chloride (for example, GaCl₃) in which the source is not easily decomposed at high temperature is used. Therefore, a GaN film can be formed with high uniformity between the surfaces of the plurality of wafers, while improving productivity.

In addition, the first gas nozzle is configured to supply hydrogen gas and nitrogen gas along with ammonia gas to adjust a concentration of ammonia gas. In addition, the second gas nozzle is configured to supply an inert gas for dilution along with GaCl₃ to adjust a concentration of GaCl₃.

Here, the above-mentioned gas supply unit may have a configuration including at least one of the first gas supply pipe 243a, the second gas supply pipe 243b, the gas supply source 240a, the gas supply source 240b, the gas supply source 240c, the gas supply source 240d, the gas supply source 240e, the gas supply source 240f, the opening and closing valve 241a, the opening and closing valve 241b, the opening and closing valve 241c, the opening and closing valve 241d, the opening and closing valve 241e, the opening and closing valve 241f, the opening and closing valve 241g, the MFC 242a, the MFC 242b, the MFC 242c, the MFC 242d, the MFC 242e, the MFC 242f, and the MFC 242g.

### Gas Exhaust Section and Gas Exhaust Port

The sidewall of the inner tube 204 is provided with a gas exhaust section 204b constituting a portion of the sidewall of the inner tube 204 along a direction in which the wafer 200 is loaded. The gas exhaust section 204b is provided on locations opposite to the plurality of gas nozzles disposed in the inner tube 204 with the wafer 200 housed in the inner tube 204 interposed therebetween. In addition, a width of the gas exhaust section 204b in the circumferential direction of the inner tube 204 may be larger than a width between the gas nozzles in both of the ends of the plurality of gas nozzles disposed in the inner tube 204. In this embodiment, the gas exhaust section 204b is provided on locations (180° opposite to the first gas nozzle 233a and the second gas nozzle 233b) opposite to the first gas nozzle 233a and the second gas nozzle 233b with the wafer 200 interposed therebetween. In addition, the width of the gas exhaust section 204b in the circumferential direction of the inner tube 204 may be larger than a distance between the first gas nozzle 233a and the second gas nozzle 233b.

The gas exhaust port 204a is formed on a sidewall of the gas exhaust section 204b. The gas exhaust port 204a is formed on locations (for example, about 180° opposite to a vaporized gas jet 248a and a reactive gas jet 248b) opposite to the vaporized gas jet 248a and the reactive gas jet 248b with the wafer 200 interposed therebetween. The gas exhaust port 204a according to this embodiment has a hole shape and is disposed on a location (height location) corresponding to each of the plurality of wafers 200. Thus, a space 203a interposed between the outer tube 203 and the inner tube 204 is communicated with a space within the inner tube 204 through the gas exhaust port 204a. In addition, an opening diameter of the gas exhaust port 204a can be suitably adjusted to optimize flow rate distribution or velocity distribution of gas in the inner tube 204. For example, the opening diameter may be adjusted to be the same across the upper part from the lower part and gradually increased across the upper part from the lower part.

In addition, a height location of a lower end of the gas exhaust section 204b preferably corresponds to a height location of the wafer of the lowermost end among the wafers 200 that are loaded into the processing chamber 201. Similarly, a height location of an upper end of the gas exhaust section 204b preferably corresponds to a height location of the wafer of the uppermost end among the wafers 200 that are loaded into the processing chamber 201. This is because if the gas exhaust section 204b is provided up to a region in which there is no wafer 200, a gas flowing between the wafers 200 may flow to the region in which there is no wafer 200 and thus an effect of a flow/side vent method may be reduced.

### Exhaust Unit

An exhaust pipe 231 is connected to the sidewall of the manifold 209. The exhaust pipe 231 is provided with a pressure sensor 245 as a pressure detector, an auto pressure controller (APC) valve 231a as a pressure regulator, a vacuum pump 231b as a vacuum exhaust device, and a harmful component removing device 231c for removing harmful components from an exhaust gas, in order from an upstream side thereof. The pressure within the inner tube 204 can be adjusted to a desired pressure by adjusting an opening and closing degree of an opening and closing valve of the APC valve 231a while operating the vacuum pump 231b. The exhaust unit may be mainly configured to include the exhaust pipe 231, the pressure sensor 245, the APC valve 231a, the vacuum pump 231b, and the harmful component removing device 231c.

As described above, the space 203a interposed between the outer tube 203 and the inner tube 204 is communicated with the space within the inner tube 204 through the gas exhaust port 204a. Thus, a gas flow 10 from the first gas jet 248a and the second gas jet 248b toward the gas exhaust port 204a in the horizontal direction is generated within the inner tube 204 by evacuating the space 203a interposed between the outer tube 203 and the inner tube 204 by the exhaust unit, while supplying a gas to the inner tube 204 through the first gas nozzle 233a or the second gas nozzle 233b.

### Controller

A controller 280, which is a control unit, is connected to the heater 207, the APC valve 231a, the vacuum pump 231b, the rotation mechanism 267, the boat elevator 215, the opening and closing valve 241, the MFC 242, and the like, respectively. The controller 280 controls a temperature adjustment operation of the heater 207, pressure and opening and closing adjustment operations of the APC valve 231a, starting and stopping of the vacuum pump 231b, the rotational speed adjustment of the rotation mechanism 267, an elevating operation of the boat elevator 215, opening and closing operations of the opening and closing valve 241, flow rate adjustment of the MFC 242 or the like.

### Substrate Processing Process

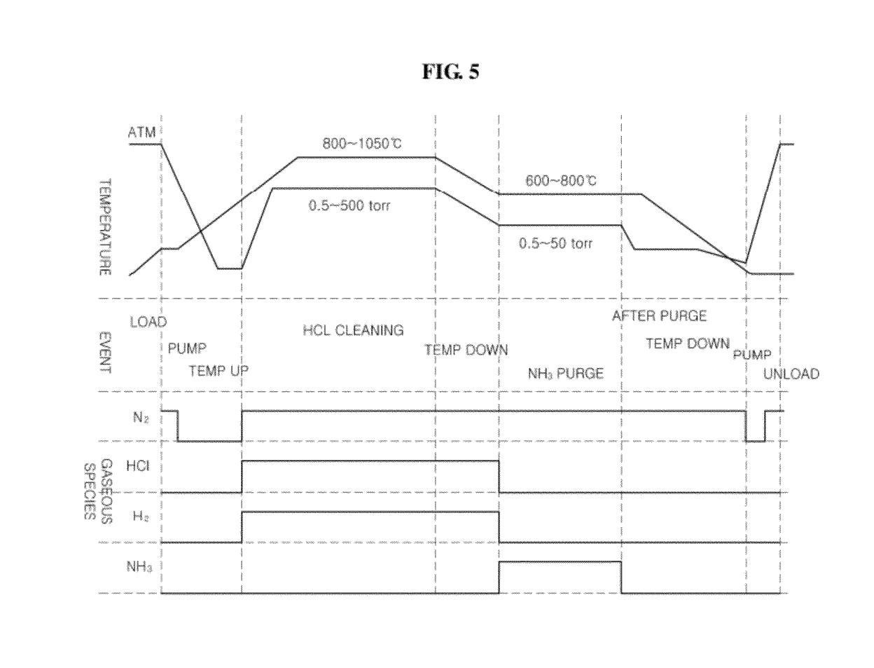

Next, one embodiment of a manufacturing process of a substrate of the present invention, which is one of manufacturing processes of a semiconductor device such as an LED, will be described with reference to FIG. 5. In addition, in the manufacturing process of the substrate, a manufacturing process using a sapphire substrate as a carrier substrate is described as one example below, and each member of the above-mentioned substrate processing apparatus is controlled by the controller 280.

Although each process will be described in detail later, a substrate processing process in this embodiment is performed mainly in the following order (1) a substrate surface processing process of cleaning a substrate surface, (2) an initial layer forming process of forming an amorphous film of GaN, and (3) an epitaxial layer forming process of forming an epitaxial layer (hereinafter referred to as an Epi layer) of GaN on the initial layer.

Here, in the initial layer forming process of forming an amorphous film of GaN, when GaCl₃, which is representative of gallium chloride, and NH₃ are used in the Epi layer forming process, the reaction between GaCl₃ and NH₃ is explosive. In addition, since a film-forming rate is very fast at about 20 nm/min, there is a possibility that control of a film thickness is worse. Accordingly, in this embodiment, considering the control of film thickness, in the initial layer forming process, supply of gallium chloride gas (for example, GaCl₃) and ammonia gas is performed by alternately performing purging while not supplying gallium chloride gas (for example, GaCl₃) and ammonia gas at the same time. More specifically, the initial layer is formed by repeating a cycle including: step 1 of saturatedly adsorbing GaCl₃ molecules on a substrate by supplying a gas including the GaCl₃ to the substrate; step 2 of removing the GaCl₃ remaining in a furnace, etc. without adsorption on the substrate by supplying an inert gas or sucking; step 3 of forming a GaN film by supplying a gas including NH₃ and then reacting with the NH₃ and the GaCl₃ adsorbed on the substrate; and step 4 of removing the NH₃ remaining in the furnace by supplying the inert gas or sucking. Accordingly, even when a source gas in the Epi layer forming process is used, the control of the film thickness can be improved. In addition, if the desired film thickness may be achieved by performing steps 1 to 4 one time, there is no need to repeat steps 1 to 4.

Hereinafter, each process will be described in detail.

Here, in each event described in FIG. 5, “Load” represents a substrate loading process to be described later, “Pump” represents a reduced pressure process to be described later and a raised temperature process, which returns to the atmospheric pressure, “Temp up” represents a raised temperature process to be described later, “HCI Cleaning” represents a cleaning process for cleaning an inside of the processing chamber to be described later, after forming an Epi layer, “Temp down” represents a lowered temperature process after the cleaning process and after a purge process to be described later, “NH₃ Purge” represents a cleaning gas removing process to be described later, “After Purge” represents a purge process to be described later, and “Unload” represents a process for unloading a boat loaded by the substrate loading process.

### Substrate Loading Process

First, the plurality of wafers 200 are charged (wafer charging) into the boat 217. Then, the boat 217 holding the plurality of wafers 200 is lifted by the boat elevator 215 to be loaded (boat loading) into the inner tube 204. In this state, the seal cap 219 is in a state in which the lower end of the manifold 209 is sealed through an O-ring 220b.

### Reduced Pressure and Raised Temperature Process

Subsequently, in order to obtain the desired processing pressure (degree of vacuum) in the inner tube 204 (in the processing chamber 201), the inner tube 20 is evacuated by the vacuum pump 231b. In this case, the opening and closing degree of the APC valve 231a is feedback-controlled based on the pressure measured by a pressure sensor 245. In addition, current flow amounts to the heater 207 are adjusted so that the surface of the wafer 200 reaches a desired processing temperature. In this case, the current flow state is feedback-controlled based on temperature information detected by a temperature sensor. In addition, the boat 217 and the wafer 200 rotate by the rotation mechanism 267.

In addition, conditions by which the reduced pressure and raised temperature processes end are described below.

Processing Pressure: 133˜13,300 Pa, preferably 1,330˜6,650 Pa

Processing Temperature: 800˜1,200° C., preferably 900˜1,100° C.

### Substrate Surface Processing Process

Next, the processing chamber 201 is stable at the desired temperature, the opening and closing valve 241b is opened, and hydrogen gas is supplied as an etching gas to the processing chamber 201 through the first gas nozzle 233a to clean the surface of the substrate. A flow rate of the hydrogen gas is determined by controlling the MFC 242b.

### Initial Layer Forming Process

Subsequently, the vacuum pump or the APC valve 231a is controlled such that the pressure in the inner tube 204 (in the processing chamber 201) may be a desired processing pressure (degree of vacuum). In addition, in parallel, the heater 207 is controlled so that the temperature of the inner tube 204 may be a desired temperature. Specifically, when a predetermined cleaning time has elapsed, a temperature in the processing chamber 201 is reduced up to a processing temperature, for example, a predetermined temperature between 500° C. and 700° C. in a next process. In addition, the hydrogen gas is continuously supplied into the processing chamber 201 and the processing chamber 201 is evacuated to be a desired pressure. In this case, as in the reduce pressure and raised temperature processes, feedback control is carried out based on values detected by the pressure sensor and the temperature sensor to manage the temperature and the pressure. In addition, the desired pressure and temperature may be as described below.

Processing Pressure: 66˜13,330 Pa, preferably, 66˜1,333 Pa,

Processing Temperature: 450˜650° C., preferably, 550° C.

After the processing chamber 201 is stable at the desired pressure and temperature, supplying of a source gas starts in order to form an underlying buffer film to be an initial layer. In this embodiment, the opening and closing valves 241e and 241f are first opened and the gallium chloride gas (for example, GaCl₃) is supplied through the second gas nozzle 233b and, if necessary, an inert gas (for example, Ar) for dilution may be supplied through the MFC 242f (gallium source gas supplying process). In addition, a carrier gas (for example, Ar) is supplied to the tank 245 in which the gallium chloride is stored in the liquid phase through the MFC 242g and the opening and closing valve 241g such that the gallium chloride gas is supplied by unloading the gallium chloride gas vaporized in the tank along with the carrier gas.

Here, the GaCl₃ is adsorbed on a surface of the substrate by flowing a gas containing the gallium chloride for a predetermined time. Next, the opening and closing valves 241f and 241e are closed, and the vacuum pump and the APC valve 231a are controlled such that the gallium chloride gas and the inert gas for dilution in the processing chamber 201 are purged (purge process). In addition, in the purge process, the nitrogen gas (N₂), which is an inert gas, may be supplied in a state in which the opening and closing valve 241f is not closed, or in a state in which the opening and closing valve 241c is opened, or in both states.

After the gallium chloride gas is evacuated, the opening and closing valves 241a and 241b are opened to supply ammonia gas (NH₃), and hydrogen gas (H₂) if necessary. Flow rates of the NH₃ gas and the hydrogen gas may be controlled by the MFCs 242a and 242b. Accordingly, chlorine atoms of GaCl₃ adsorbed on the substrate surface are replaced with nitrogen atoms of NH₃ to form a GaN film on the substrate surface (ammonia gas supplying process). In addition, the replaced chlorine atoms are exhausted in the form of HCl by reacting with the hydrogen atoms.

Subsequently, the opening and closing valves 241a and 241b are closed, and the vacuum pump and the APC valve 231a are controlled such that ammonia and hydrogen gas in the processing chamber 201 are purged (purge process). In addition, in the purge process, the nitrogen gas (N₂), which is an inert gas, may be supplied in a state in which the opening and closing valve 241c is not closed, or in a state in which the opening and closing valve 241c is opened, or in both states.

A series of processes of “the gallium source gas supplying process”→“the purge process”→“the ammonia gas supplying process”→“the purge process” are repeatedly performed to form an initial layer having a desired thickness (for example, 10˜100 nm, preferably, 2050 nm). In addition, since the initial layer is formed at the low-temperature region, the initial layer may be in an amorphous state.

Examples of the conditions in the initial layer forming process are described below.

GaCl₃ Flow Rate: 5˜500 sccm

(Carrier Ar: 10˜5,000 sccm)

Dilution Ar Flow Rate: 100˜5,000 sccm

NH₃ Flow Rate: 100˜50,000 sccm

H₂Flow Rate: 100˜50,000 sccm

### Epi Layer Forming Process

Subsequently, the vacuum pump or the APC valve 231a is controlled such that the pressure in the inner tube 204 (in processing chamber 201) may be a desired pressure (degree of vacuum). In addition, in parallel, the heater 207 is controlled such that the temperature of the inner tube 204 may be a desired temperature. In addition, examples of the desired pressure and temperature may be as described below.

Processing Pressure: 20˜13,300 Pa, preferably, 2,660 Pa,

Processing Temperature: 850˜1,150° C., preferably, 1,050° C.

After reaching the desired pressure and temperature, the opening and closing valves 241a, 241b, 241c and 241d are opened such that gallium chloride gas, an inert gas for dilution, ammonia gas, and hydrogen gas may be supplied in parallel. Accordingly, the gallium chloride gas and the ammonia gas react with each other, and thus a GaN epitaxial layer (hereinafter referred to as an Epi layer) is formed at a faster rate when compared with the initial layer formation. The Epi layer forming process is continued until the Epi layer having a desired thickness is formed.

Examples of the conditions in the Epi layer forming process are described below.

Pressure: 20˜13,300 Pa

Temperature: 850˜1,150° C.

GaCl₃ Flow Rate: 5˜500 sccm

(Carrier Ar: 10˜5,000 sccm)

Dilution Ar Flow Rate: 100˜50,000 sccm

NH₃ Flow Rate: 100˜50,000 sccm

H₂Flow Rate: 100˜50,000 sccm

### Elevating Process, Substrate Unloading Process

After a GaN film having a desired thickness is formed on the wafer 200, an opening degree of the APC valve 231a is reduced such that pressure in the process tube 205 (in the inner tube 204 and the outer tube 203) is set to atmospheric pressure. Then, the wafer 200 on which the film forming is completed is unloaded from the inner tube 204 in substantially reverse order of the substrate loading process.

In the above-mentioned processes, a GaN film can be formed using a so-called vertical batch type substrate processing apparatus in which the processing is performed such that the substrates are arranged in the longitudinal direction by forming the GaN film on the substrate.

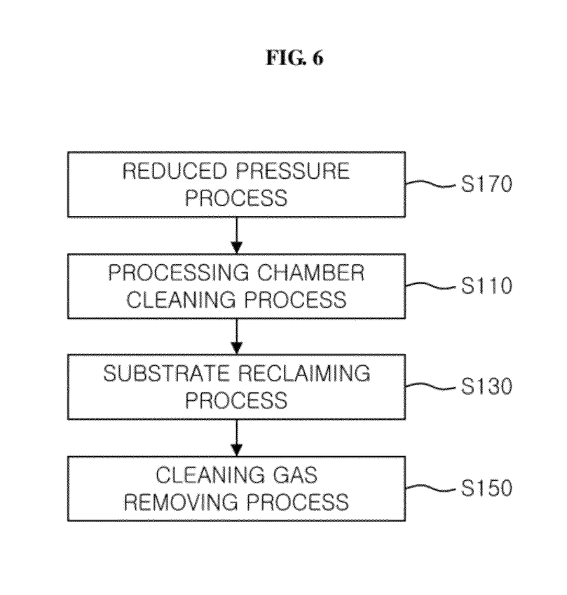

In addition, the cleaning of the carrier substrate surface in the processing chamber will be described with reference to FIGS. 5 and 6.

### Cleaning Process in Processing Chamber

After forming the Epi layer, self-cleaning is performed in the processing chamber 201. When the cleaning is performed in the processing chamber 201, the boat 217 is transported into the processing chamber 201 in a state in which the wafer 200 is not mounted, or a state in which a dummy wafer is mounted. Thus, when an inside of the processing chamber 201 is in a sealed state by loading the boat, conditions in which the inner temperature of the processing chamber 201 is raised up to a predetermined temperature and an atmosphere is intensified up to a predetermined pressure are set as conditions in the processing chamber 201 capable of performing the cleaning. Meanwhile, when the inside of the processing chamber 201 is in a sealed state by loading the boat, a reduced pressure process (S170, “pump” of FIG. 5) of reducing a pressure is first performed, and then the pressure can be increased up to a predetermined pressure. When the inside of the processing chamber 201 satisfies the predetermined conditions, a chlorine-based gas (for example, HCl), hydrogen gas (H₂) and nitrogen gas (N₂), which are reactive gases, are supplied, and the reactive gases are continuously supplied until attachment matters attached to the surface of parts in the processing chamber including a GaN film are completely etched. When a predetermined time of etching has elapsed, the supplying of the reactive gases stops, and an inert gas is supplied to replace the atmosphere in the processing chamber 201. After replacing the atmosphere, the temperature is lowered to a predetermined temperature, and the pressure returns to the atmospheric pressure. The attachment matters attached to the surface of parts in the processing chamber are etched so as to suppress the influence of the attachment matters on the film-forming process. The cleaning process S110 for cleaning the inside of the processing chamber described above may be performed every time after forming the GaN film, or may be performed every predetermined number of times.

Examples of the conditions in the cleaning process S110 for cleaning the inside of the processing chamber are described below.

Pressure: 0.5˜500 Torr

Temperature: 800˜1050° C.

HCl Flow Rate: 0.05˜5.00 slm

N₂ Flow Rate: 0˜10 slm

H₂Flow Rate: 0˜10 slm

Here, in the above-described conditions, the cleaning process for cleaning the inside of the processing chamber may be performed at a pressure of 5 Torr to 400 Torr and at a temperature of 800° C. to 1,000° C.

### Carrier Substrate Reclaiming Process

When the cleaning process in the processing chamber 201 is completed, a reclaiming process S130 of the carrier substrate is performed after peeling the GaN film. After the cleaning process S110 in the processing chamber 201 is completed, the boat on which the carrier substrate is mounted after peeling the GaN film is transported into the processing chamber 201. Thus, when the processing chamber 201 is in a state sealed by loading the boat, conditions in which a temperature of the processing chamber 201 is raised to a predetermined temperature and an atmosphere of the inside of the processing chamber is increased up to a predetermined pressure are set as predetermined conditions. When the inside of the processing chamber 201 satisfies the predetermined conditions, a chlorine-based gas (for example, HCl), hydrogen gas (H₂) and nitrogen gas (N₂), which are reactive gases, are supplied, and the reactive gases are continuously supplied until attachment matters attached to the surface of parts in the processing chamber including a GaN film are completely etched. When a predetermined time of etching has elapsed, the supplying of the reactive gas stops, and an inert gas is supplied to replace the atmosphere in the processing chamber 201. After replacing the atmosphere, the temperature is lowered to a predetermined temperature, and the pressure returns to the atmospheric pressure. By performing the above-mentioned process, the GaN film on the carrier substrate is etched, and thus it is possible to operate as the reclaiming or process of the carrier substrate.

Examples of the conditions in the carrier substrate reclaiming process S130 are described below.

Pressure: 0.5˜500 Torr

Temperature: 800˜1,050° C.

HCl Flow Rate: 0.05˜5.00 slm

N₂ Flow Rate: 0˜10 slm

H₂Flow Rate: 0˜10 slm

Here, in the above-described conditions, the carrier substrate reclaiming process may be performed at a pressure of 5 Torr to 500 Torr and at a temperature of 850° C. to 1,000° C.

### Cleaning Gas Removing Process

When the cleaning process S110 for cleaning the inside of the processing chamber and the carrier substrate reclaiming process S130 end, a process S150 of removing the chlorine-based gas (Cl element) attached to the carrier substrate or parts in the processing chamber due to the reactive gas used in the processes is performed. When the carrier substrate reclaiming process S130 ends, the supply of the ammonia gas NH₃ starts. The supplied ammonia gas reacts with the chlorine-based gas attached to the carrier substrate or parts in the processing chamber to form ammonium chloride NH₄Cl. Then, in order to volatilize the formed ammonium chloride, a pressure, a temperature, an ammonia gas flow rate, and a nitrogen gas flow rate in the inside of the processing chamber, which are predetermined conditions, are set and a purge process may be performed, thereby reducing Cl attachments to surfaces of a heat-resistant non-metallic member or the carrier substrate. In order to exhaust the volatilized ammonium chloride, the atmosphere in the inside of the processing chamber is replaced with the inert gas, and then the temperature is lowered and the pressure is returned to the atmospheric pressure.

Examples of the conditions in the cleaning gas removing process S170 are described below.

Pressure: 0.5˜50 Torr

Temperature: 600˜800° C.

NH₃ Flow Rate: 0.05˜5.00 slm

N₂ Flow Rate: 0˜10 slm

### Second Embodiment

Next, a second embodiment of the present invention will be described. This second embodiment is different from the first embodiment in that a GaN film is formed in advance, a sapphire substrate is again reclaimed using a substrate completed in peeling of the GaN film and the carrier substrate, and the GaN film is formed on the reclaimed sapphire substrate. That is, the reclaiming process of the sapphire substrate is incorporated with a process of the GaN film formation, and the reclaiming of the sapphire substrate and the forming of the GaN can be performed at one time. In other words, since the process of forming the GaN film is continuously performed as usual after performing the reclaiming process of the sapphire substrate, the GaN film can be formed using the reclaiming of the sapphire substrate and the reclaimed sapphire substrate.

Specifically, the cleaning process S110 for cleaning the inside of the processing chamber 201 is first performed. When the cleaning process for cleaning the inside of the processing chamber 201 ends, the reclaiming process S130 of the used carrier substrate completed in peeling of the GaN film and the carrier substrate is performed, and thus the cleaning gas process S150 is performed after the reclaiming process S130 of the carrier substrate ends. Here, in the cleaning process S110 for cleaning the inside of the processing chamber, the carrier substrate reclaiming process S130 and the cleaning gas process S150, since processing conditions, processing procedures and the like of each process are the same as in the first embodiment described above, a detail description is omitted.

As described above, because the self-cleaning in the processing chamber after forming the Epi film and the etching of the substrate whose thickness could not be controlled on which forming film is completed are performed by the same process, although only an etching condition is changed, processing can be performed and be processed and it is possible to use as a process of the procedure. In addition, the influence on the next processing can be suppressed by post-processing the chlorine gas attached to surfaces of parts of the processing chamber with ammonia gas by the self-cleaning. In addition, the carrier substrate reclaiming processing may be performed at the beginning using a sapphire substrate used as the wafer which is used in the substrate processing apparatus. Thus, since the substrate processing can be performed as a series of processes, without performing the sapphire substrate loading processing after peeling the GaN film, a substrate processing throughput can be improved.

### Third Embodiment

Next, a third embodiment of the present invention will be described.

This third embodiment is different from the first embodiment in that the cleaning gas used in the first embodiment is changed from HCl gas to Cl₂ gas to supply changed HCl gas. That is, the cleaning may be performed at a low temperature by changing the cleaning gas from HCl gas to Cl₂ gas, and the sapphire substrate reclaiming may be performed efficiently.

Specifically, as in the first embodiment, after forming an Epi layer, the sapphire substrate is reclaimed by performing the cleaning process S110 in the processing chamber 201, the carrier substrate reclaiming process S130, and the cleaning gas removing process S150. Here, processing conditions of the cleaning gas removing process S150 are identical to those in the first embodiment.

By supplying Cl₂ gas, a following chain reaction may be caused, thereby promoting improvements of an etching rate with etching properties based on HCl.

Cl₂(gas)→2Cl(pyrolysis)

H₂(gas)+Cl₂(gas)→HCl(gas)+(H)+(Cl)

2GaN(solid)+2HCl(gas)→2GaCl(gas)+H₂(gas)+N₂(gas)

2GaN(solid)+Cl₂(gas)→2GaCl(gas)+N₂(gas)

2GaN(solid)+2H₂(gas)→Ga+GaH(gas)+½N₂(gas)+NH₃(gas)

In addition, examples of the conditions in the cleaning process S110 for cleaning the inside of the processing chamber are described below.

Pressure: 0.5˜400 Torr

Temperature: 600˜950° C.

Cl₂: Flow Rate 0.05˜5.00 slm

N₂: Flow Rate 0˜10 slm

H₂: Flow Rate 0˜10 slm

Here, in the above-described conditions, the cleaning process for cleaning the inside of the processing chamber may be performed at a pressure of 5 Torr to 400 Torr.

In addition, examples of the conditions in the carrier substrate reclaiming process S130 are described below.

Pressure: 0.5˜500 Torr

Temperature: 650˜1,050° C.

Cl₂: Flow Rate 0.05˜5.00 slm

N₂: Flow Rate 0˜10 slm

H₂: Flow Rate 0˜10 slm

Here, in the above-described conditions, the carrier substrate reclaiming process may be performed at a pressure of 5 Torr to 500 Torr.

As described above, in the third embodiment, the processing at a low temperature using Cl₂ as the cleaning gas can be performed and the sapphire substrate with high efficiency can be safely reclaimed. In addition, the Cl₂ gas may be supplied alone, or the Cl₂ gas may be supplied along with H₂ gas at the same time, thereby improving efficiency with etching properties based on HCl.

Though the present invention has been described in accordance with the embodiments, various modifications are possible without departing from the scope of the present invention. For example, the present invention has been described by illustrating a so-called vertical batch-type substrate processing apparatus because the present invention was produced in a process of considering the formation of a GaN film using the vertical batch-type substrate processing apparatus. However, a so-called single-wafer device in which the substrate is processed one by one as well as a multi-wafer device in which a plurality of substrates are arranged in a planar shape may be continuously processed in accordance with the present invention, thereby improving a substrate processing throughput.

In addition, the cleaning process for the cleaning the inside of the processing chamber and the carrier substrate reclaiming process may be performed at the same time under a constant condition.

### Preferred Aspects of the Present Invention

Hereinafter, preferred aspects of the present invention will be supplementarily noted.

### Supplementary Note 1

According to an aspect of the present invention, there is provided a semiconductor manufacturing apparatus in which, when a thick GaN film is formed on the substrate, attachment matters attached to a surface of a heat-resistant non-metallic member after forming the film may be removed by supplying HCl as a cleaning gas under certain conditions.

Accordingly, after forming the GaN film, self-cleaning of the inside of the processing chamber may be performed, and the film-forming processing may be preformed consecutively.

### Supplementary Note 2

In the semiconductor manufacturing apparatus described in supplementary note 1, after attachment matters attached to a surface of a heat-resistant non-metallic member after forming the film are removed, the GaN film attached to the surface may be removed by cleaning the substrate using HCl for cleaning after peeling the GaN film.

Accordingly, the substrate can be reclaimed without polishing a carrier substrate.

### Supplementary Note 3

In the semiconductor manufacturing apparatus described in supplementary notes 1 or 2, a cleaning condition may be reduced pressure.

Accordingly, byproducts separated from the GaN film may be quickly evacuated, and it is possible to perform control of reducing damage of metal parts.

### Supplementary Note 4

According to another aspect of the present invention, there is provided a semiconductor device manufacturing method performed in a substrate processing apparatus including a processing chamber for processing a semiconductor substrate. The method may include a processing chamber cleaning process of cleaning an inside of the processing chamber, a substrate reclaiming process of reclaiming the semiconductor substrate, and a cleaning gas removing process of removing a cleaning gas used in one of or both of the processing chamber cleaning process and the substrate reclaiming process.

### Supplementary Note 5

In the semiconductor device manufacturing method described in supplementary note 4, the cleaning gas may be HCl or Cl₂.

### Supplementary Note 6

In the semiconductor device manufacturing method described in supplementary notes 4 and 5, the semiconductor device manufacturing method may further include a pressure reducing process of reducing an inside pressure of the processing chamber before the processing chamber cleaning process is performed.

### Supplementary Note 7

According to another aspect of the present invention, there is provided a substrate processing apparatus for processing a substrate including an epitaxial film. The substrate processing apparatus may include a processing chamber configured to process the substrate, a gas supply unit configured supply a source gas for forming the epitaxial film and a cleaning gas into the processing chamber, and a control unit configured to control at least an inside temperature and an inside pressure of the processing chamber, wherein the control unit controls the gas supply unit to supply the cleaning gas into the processing chamber when the inside temperature and the inside pressure of the processing chamber reach a predetermined temperature and a predetermined pressure, respectively.

### Supplementary Note 8

In the substrate processing apparatus described in supplementary note 7, the substrate including the epitaxial film may include a sapphire substrate including a GaN film.

What is claimed is:

1. A substrate processing method performed in a substrate processing apparatus including a processing chamber for processing a semiconductor substrate, the method comprising:
a processing chamber cleaning process of cleaning an inside of the processing chamber;
a substrate reclaiming process of reclaiming the semiconductor substrate; and
a cleaning gas removing process of removing a cleaning gas used in one of or both of the processing chamber cleaning process and the substrate reclaiming process.

2. The method according to claim 1, wherein the cleaning gas is HCl or Cl₂.

3. The method according to claim 1, further comprising a pressure reducing process of reducing an inside pressure of the processing chamber before the processing chamber cleaning process is performed.

4. A semiconductor device manufacturing method performed in a substrate processing apparatus including a processing chamber for processing a semiconductor substrate, the method comprising:
a processing chamber cleaning process of cleaning an inside of the processing chamber;
a substrate reclaiming process of reclaiming the semiconductor substrate; and
a cleaning gas removing process of removing a cleaning gas used in one of or both of the processing chamber cleaning process and the substrate reclaiming process.

5. The method according to claim 4, wherein the cleaning gas is HCl or Cl₂.

6. The method according to claim 4, further comprising a pressure reducing process of reducing an inside pressure of the processing chamber before the processing chamber cleaning process is performed.

7. A substrate processing apparatus for processing a substrate including an epitaxial film, comprising:
a processing chamber configured to process the substrate;
a gas supply unit configured supply a source gas for forming the epitaxial film and a cleaning gas into the processing chamber; and
a control unit configured to control at least an inside temperature and an inside pressure of the processing chamber,
wherein the control unit controls the gas supply unit to supply the cleaning gas into the processing chamber when the inside temperature and the inside pressure of the processing chamber reach a predetermined temperature and a predetermined pressure, respectively.

8. The apparatus according to claim 7, wherein the substrate including the epitaxial film comprises a sapphire substrate including a GaN film.
